(19) United States
(12) Patent Application Publication
(10) Pub. No.: US 2006/0187073 A1
(43) Pub. Date: Aug. 24, 2006

(54) ENERGY STATUS INDICATOR IN A PORTABLE DEVICE

(76) Inventors: Chao-Hua Lin, Taipei Hsien (TW); Ivan Su, Sacramento, CA (US)

Correspondence Address: NORTH AMERICA INTELLECTUAL PROPERTY CORPORATION, P.O. BOX 506, MERRIFIELD, VA, 22116, US

(21) Appl. No.: 10/906,404

(22) Filed: Feb. 18, 2005

(51) Int. Cl. G08B 21/00; H02J 7/00

(52) U.S. Cl. 340/636.15; 320/136

(57) ABSTRACT

An energy status indicator for a portable device includes an alert device, an activation sensor, an energy status indicator, an alert triggering device and an alert database that includes alert data. The activation sensor is for detecting if the portable device is activated and the energy status indicator is used for determining a level of remaining energy in an energy storage. The alert triggering device includes coded program which is for outputting alert data corresponding to the level of remaining energy through the alert device, after the portable device's activation. The energy status indicator gives a user control over when the energy status is to be output and also to the type of alert that is to be output (e.g. sound, vibration, etc.). Additionally, it allows the user to determine the energy status when visual inspection of the portable device is not possible.

### BACKGROUND OF INVENTION

1. Field of the Invention

The present invention relates to an electronic portable device, and more specifically, to an energy status indicator in a portable device.

2. Description of the Prior Art

Nowadays, portable devices such as cellular phones or PDAs are becoming ever more popular. Due to their increased popularity, manufacturers are continuously developing various new features in an attempt to provide more useful functionality to these portable devices. One of these features is the energy status indicator, whose task is to indicate the amount of energy left in the device's energy storage.

The prior art explains the workings of the energy status indicator as being very simple—if the energy status indicator detects that the energy remaining in the energy storage is low then the portable device beeps.

Please refer to FIG. 1, which illustrates the prior art logic associated with generating an audible low battery indicator. Audible low-battery indicator logic 100 comprises a central processing unit (CPU) 102, an energy status indicator 104, a battery 106, a ‘beep’ sound data 108, a speaker 110, and an activation sensor 112. The CPU 102 is able to determine when the portable device has become activated by querying the activation sensor 112. Also the CPU 102 can interpret the energy status indicator 104 and convert the ‘beep’ sound data 108 into audible sound via the speaker 110. The energy status indicator 104 determines the level of remaining energy in the battery 106.

Please refer to FIG. 2 in conjunction with FIG. 1. A flowchart 200 displaying the sequence of events leading to the generation of an audible low-battery indicator is illustrated. The flowchart 200 comprises the following steps:

Step 210: Start. (The activation sensor 112 detects that the device has been activated)

Step 220: ‘Is the Battery low?’ (The energy status indicator 104 checks if the battery 106 is low and if the answer is ‘yes’ step 230 ensues and if it's ‘no’ then step 240 follows)

Step 230: Phone beeps (The energy status indicator 104 notifies the CPU 102 that the battery 106 is low, hence the CPU 102 converts the ‘beep’ sound data 108 into audible sound that is played on the speaker 110)

Step 240: End. (The user can now continue with other phone operations)

Unfortunately, the prior art's energy status indicator, as well as the manner in which is employed within the portable device's framework, has a few serious drawbacks.

First of all, the ‘beep’ sound data emitted by the portable device, when the energy storage is low, is hard-coded. As a result, the user is not offered the option of choosing a different type of warning.

Furthermore, the prior art offers only a visual queue for the energy status indicator as the only means of informing the user of the energy left in the battery, when the battery is not low. This is an inconvenience which can be especially felt when the user voluntarily desires to verify the battery status. He may be unable to do so for a variety of reasons which could be either user or device induced. The user induced reasons can be that the person is blind or the person is driving. The device induced reasons can be that the day is very sunny preventing the user from discerning what is being displayed or that the portable device's display is broken.

### SUMMARY OF INVENTION

It is therefore a primary objective of the invention to provide an energy status indicator that solves the above-mentioned problems of the prior art.

According to the invention, an energy status indicator comprises an alert device, an alert database including alert data, an activation sensor, an alert triggering device including coded program, and an energy status indicator. The activation sensor detects if the portable device is initially activated after a duration of inactivity and the energy status indicator determines a level of remaining energy in an energy storage device. Then, the alert triggering device outputs a portion of the alert data corresponding to the determined level of remaining energy through the alert device, which can be a speaker, vibrator, or the like.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram illustrating prior art logic associated with generating an audible low battery warning.

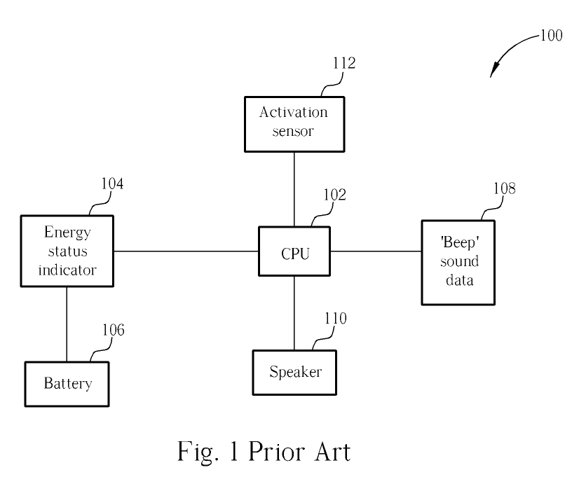

FIG. 2 is a flowchart illustrating the sequence of events leading to the audible warning, with respect to components shown in FIG. 1.

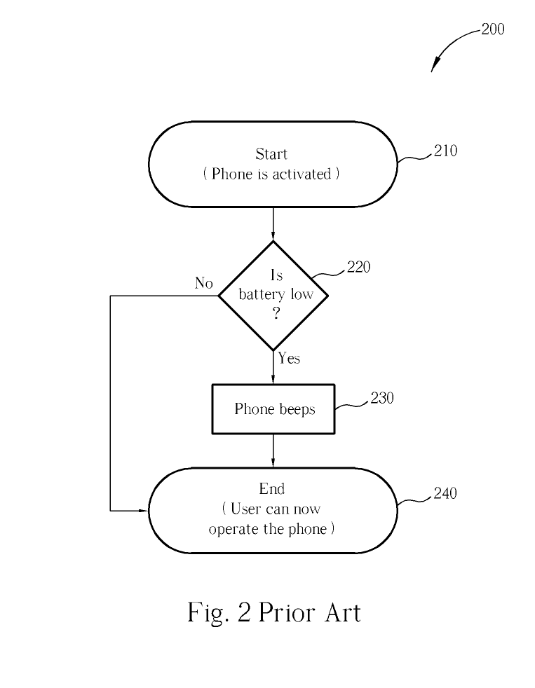

FIG. 3 is a simplified view of a conventional ‘flip’ cellular phone with a mechanical activation sensor according to the present invention.

FIG. 4 is a simplified view of a conventional ‘non-flip’ cellular phone with an electromagnetic activation sensor according to the present invention.

FIG. 5 is a block diagram illustrating an energy status indicator according to the present invention.

FIG. 6 is a flowchart illustrating the sequence of events leading to sound generation by the energy status indicator of FIG. 5.

### DETAILED DESCRIPTION

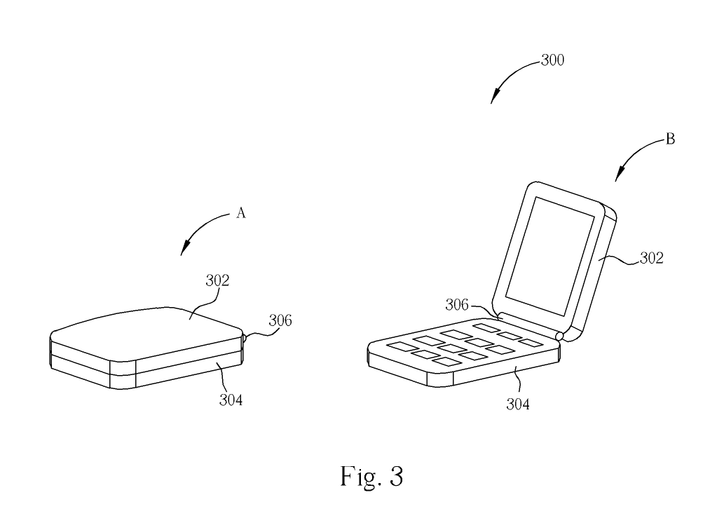

Please refer to FIG. 3 which depicts a conventional ‘flip’ cellular phone 300. The ‘flip’ cellular phone 300 comprises an upper part 302, a lower part 304 and a mechanical activation sensor 306.

The ‘flip’ cellular phone 300 is in closed position A as determined by the upper part 302 horizontally hugging the lower part 304. In closed position A, the mechanical activation sensor 306 has not been triggered causing the phone to remain inactivate.

The ‘flip’ cellular phone 300 is in open position B as determined by the upper part 302 being separated from lower part 304 by a certain distance. In open position B, the mechanical activation sensor 306 is mechanically triggered by the separation of upper part 302 from lower part 304, causing the phone to become activated.

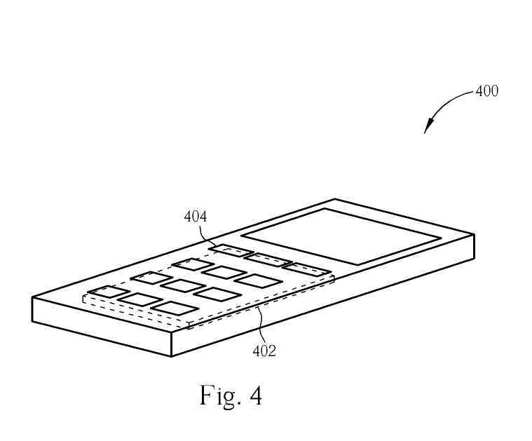

Please refer to FIG. 4 which illustrates a conventional ‘non-flip’ cellular phone 400. The ‘non-flip’ cellular phone 400 includes an electromagnetic activation sensor 402 and keys 404.

The electromagnetic activation sensor 402 is triggered when the any of the keys 404 are pressed. At this point, the ‘non-flip’ cellular phone 400 is deemed to be activated. If none of the keys 404 are pressed the electromagnetic activation sensor 402 is not triggered and the ‘non-flip’ cellular phone 400 continues to be inactivated.

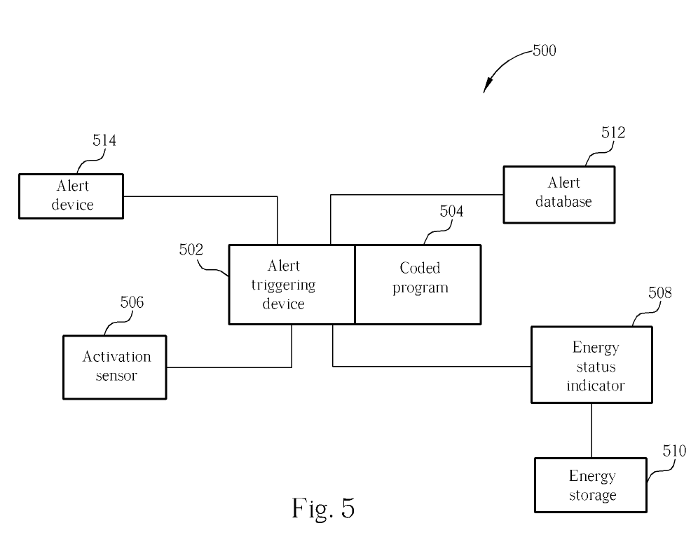

Please refer to FIG. 5 where an energy status indicator 500 is shown according to the present invention. The energy status indicator 500 comprises an alert triggering device 502, an activation sensor 506, an energy status indicator 508, an energy storage device 510 such as a battery, an alert database 512, and an alert device 514.

The activation sensor 506 is used for detecting if the portable device has been activated after a duration of inactivity. Typically, the sensor 506 will be a device such as the sensor 306 or sensor 402 described above. The activation sensor 506 can be a hall sensor or a keypad sensor, without being limited to one of these. The activation sensor 506 can also be an electromagnetic sensor or a mechanical sensor, without being limited to one of these. Additionally, the activation 506 sensor can also be a combination electrical-mechanical sensor. Generally, the term “activation” used herein means that a user had affected the state of the portable device by manually opening it, pushing a button of a keypad, or even just turning on the power of the portable device, without being limited to such. Moreover, the general power to the portable device need not be on nor off for the portable device to be activated.

The alert triggering device 502 comprises a coded program 504 that can either be firmware code or software code. The alert triggering device 502 is coupled to the activation sensor 506, alert database 512, energy status indicator 508, and alert device 514. When the activation sensor 506 detects that the portable device is initially activated, the alert triggering device's 502 coded program 504 outputs (or executes) a portion of the alert data corresponding to the determined level of remaining energy in the energy storage device 510 through the alert device 514. The level of remaining energy in the energy storage device 510 is determined by the energy status indicator 508.

The levels of remaining energy of the energy storage 510 as reported by the energy status indicator 508 are discrete and have a one-to-one correspondence to portions of alert data that each correspond to a distinct alert.

The alert database 512 comprises alert data that can be synthesized through a speaker forming part of the alert device 514 as audible beeps, melodies, or any humanly differentiable kind of sound (e.g. decreasing volume with decreasing battery life). Equally, the alert data that can be synthesized through a vibrator forming part of the alert device 514 as distinct levels of vibration (e.g. strong vibration for high battery life and a weak vibration for low battery life). In addition, other types of alerts can also be used with the present invention; any alert that can be separated into levels that can be sensed and distinguished by a human being is acceptable (i.e. it is sensible). With improvements in the related technologies, alerts could include thermal alerts or perhaps olfactory alerts. Moreover, when the alert device is formed from a combination of different alert units (e.g. a speaker and a vibrator) a new dimension of alerts is possible with the present invention. That is, normal battery levels could be indicated by a pleasant melody of decreasing volume with decreasing battery life, and a critically low battery level could be indicated by a loud, attention-grabbing melody and a simultaneous strong vibration.

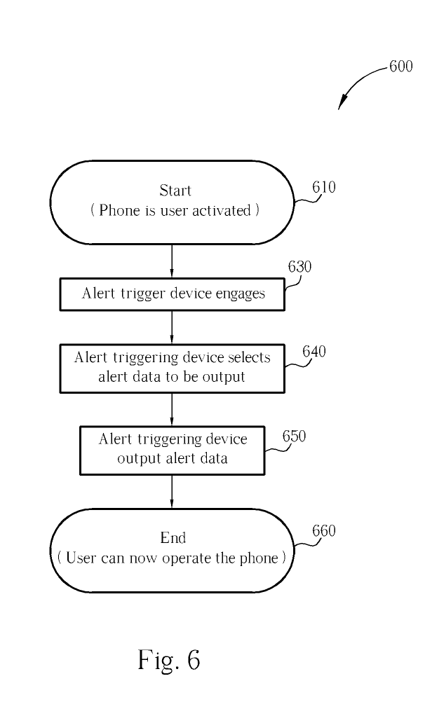

Please refer to FIG. 6 in conjunction with FIG. 5. A flowchart 600 displaying a sequence of events leading to the generation of an low-battery indicator is illustrated. The flowchart 600 comprises the following steps:

Step 610: Start (The activation sensor 506 detects that the device has been activated by the user)

Step 630: The alert triggering device 502 is engaged (the coded program 504 is run)

Step 640: The alert triggering device 502 selects the alert data (it does so by having the coded program 504 access the alert database 512 and select alert data to be outputted depending on the remaining amount of energy left in the energy storage device 510, as reported by the energy status indicator 508)

Step 650: The alert triggering device 502 plays the alert data (the alert triggering device 502 forwards the alert data to the alert device 514, which synthesizes the alert data into a human-sensible alert and performs the alert)

Step 660: End (the user can now operate the phone)

Provided that substantially the same result is achieved, the steps of the flowchart 600 need not be in the exact order shown and need not be contiguous, that is, other steps can be intermediate.

Please note that the following advantages of the present invention over the prior art will be presented by mainly referring to cellular phone, however they are applicable to any type of electronic portable device.

In contrast to the prior art's low battery beeping mechanism, the present invention's audible, vibration, or other sensory energy status feature is useful in more than one way. Firstly, it informs the user of the battery status when the visual inspection of the cellular phone's energy status indicator is not possible. This can occur due to either user-caused or device-caused reasons. The user-caused reasons could, for example, be that the user is, at the time, performing a task which requires his visual attention (i.e. driving), or the user is visually impaired. The device-caused reasons could be a cracked phone display panel, a burnt out display panel or a strong light source close to the phone's display panel, all of which would prevent the user from visually inspecting the energy status indicator reliably enough to judge the amount of energy left in the energy storage.

Secondly, in the present invention the alert triggering device is user-activated, while in the prior art the low battery beeping mechanism can only be triggered by a low battery. As such, the present invention's approach offers the user the flexibility of hearing, feeling, or sensing the level of the energy left, instead of only being able to see it. As it was described above, this can prove especially useful for the visually impaired.

Moreover, the flexibility offered by this approach can be further extended to what the alert is. Thanks to the alert database which allows the alert triggering mechanism access to a variety vibrations, beeps, melodies, or sounds of different volume, the user can be informed of the energy status in very creative and constructive ways. For example, if the battery is full then a happy melody can be played. Conversely, if the battery is not full, a number of beeps inversely proportional to the number of ‘bars’ indicated by the energy status indicator, can be played along with a vibration. Such a tactic is clearly substantially superior to the prior art's way of beeping only when the battery is low.

Additionally, by implementing the present invention's energy indicator other more subtle flaws of the prior art are adequately addressed. For instance, in some circumstances, the level of energy left in the battery might not be accurately reflected by the energy status indicator. This is the case when the energy storage device is approaching the end of its life, at which point what is shown by the energy status indicator is in fact the energy of a highly depleted battery prone to lose its energy at short intervals. In these circumstances, the present invention approach of emitting an alert upon each activation of the phone keeps the user better and regularly informed so that appropriate action, such as replacing the battery, may be taken.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An energy status indicator for a portable device comprising:
an activation sensor for detecting if the portable device is activated after a duration of inactivity;
an energy status detector for determining a level of remaining energy in an energy storage device; and
an alert device able to generate at least two sensibly distinct alerts, wherein one of the sensibly distinct alerts is outputted corresponding to the determined level of remaining energy when activation of the portable device is detected.

2. The energy status indicator of claim 1 further comprising an alert database that includes data of sensibly distinct alerts.

3. The energy status indicator of claim 2 wherein the alert device is a speaker and the data of sensibly distinct alerts are data of audible beeps or melodies.

4. The energy status indicator of claim 2 wherein the alert device is a vibrator and the data of sensibly distinct alerts are different levels of vibration.

5. The energy status indicator of claim 1 further comprises an alert triggering device that comprises a coded program to select the sensibly distinct alerts to be outputted by the alert device.

6. The energy status indicator of claim 5 wherein the coded program is a firmware program or a software program.

7. The energy status indicator of claim 1 wherein the activation sensor is a user driven sensor.

8. The energy status indicator of claim 7 wherein the activation sensor is an electromagnetic sensor.

9. The energy status indicator of claim 7 wherein the activation sensor is a mechanical sensor.

10. The energy status indicator of claim 7 wherein the activation sensor comprises a hall sensor.

11. The energy status indicator of claim 7 wherein the activation sensor comprises a keypad sensor.

12. The energy status indicator of claim 1 wherein levels of remaining energy of the energy storage are discrete and have a one-to-one correspondence to the sensibly distinct alerts.

13. The energy status indicator of claim 1 wherein the energy storage device is a battery.

14. An energy status indicator for a portable device comprising:
a alert device;
an alert database comprising alert data divided into at least two portions that each correspond to a distinctly sensible alert;
an activation sensor for detecting if the portable device is activated in response to a user input after a duration of inactivity;
an energy status component for determining a level of remaining energy in a battery; and
an alert triggering device coupled to the activation sensor, alert database, energy status component, and alert device; the alert triggering device comprising a coded program that, when the activation sensor detects that the portable device is initially activated, outputs a portion of the alert data corresponding to the determined level of remaining energy through the alert device.

15. The energy status indicator of claim 14 wherein the activation sensor is an electromagnetic sensor.

16. The energy status indicator of claim 15 wherein the activation sensor comprises a hall sensor.

17. The energy status indicator of claim 14 wherein the activation sensor is a mechanical sensor.

18. The energy status indicator of claim 17 wherein the activation sensor comprises a keypad sensor.

19. The energy status indicator of claim 14 wherein the alert device comprises a speaker and the alert data comprises code corresponding to audible beeps or melodies.

20. The energy status indicator of claim 14 wherein the alert device comprises a vibrator and the alert data comprises code corresponding to levels of vibration.

21. The energy status indicator of claim 14 wherein the coded program is a firmware program or a software program.

22. A method for outputting an energy status of a portable device, the method comprising:
detecting activation of the portable device in response to a user input;
determining a level of remaining energy in an energy storage device; and
outputting a sensible alert corresponding to the determined level of remaining energy when activation is detected.

23. The method of claim 22 wherein the user input comprises opening the portable device or pressing a button of the portable device.

24. The method of claim 22 wherein the sensible alert comprises an audible beep or melody.

25. The method of claim 22 wherein the sensible alert comprises a vibration.

26. An energy status indicator for a portable device, the energy status indicator comprising an alert device, an activation sensor, an energy status detector, an alert triggering device, and a coded program that performs the steps of claim 22.
